(19) United States
(12) Patent Application Publication
(10) Pub. No.: US 2009/0204328 A1
(43) Pub. Date: Aug. 13, 2009

(54) REFINED ANALYTICAL MODEL FOR FORMATION PARAMETER CALCULATION

(75) Inventor: George Stewart, Edinburgh (GB)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: PRECISION ENERGEY SERVICES, INC., Forth Worth, TX (US)

(21) Appl. No.: 12/029,810

(22) Filed: Feb. 12, 2008

(51) Int. Cl. G01V 9/00

(52) U.S. Cl. 702/12

(57) ABSTRACT

Disclosed herein are methods, systems, and devices for determining parameters of an earth formation. Pressure transient data from a formation test can be recorded and analyzed using an analytical model including one or more correction factors derived from an assumption that an induced flow within the formation is hemispherical. Regression analysis of the refined analytical model and the pressure transient data results in accurate earth formation parameters.

### BACKGROUND

Oil, natural gas, and other fluids can be found within the pores of rocks in an earth formation. Obtaining these desirable fluids typically involves drilling a wellbore from the earth's surface through the reservoir to eventually draw out the oil or natural gases from the formation. Typically, before a well is produced, the driller determines the amount of fluid within the reservoir, and the ability to draw that fluid from the earth formation. The amount of fluid in the reservoir and the ability to draw the fluid from the formation is an indication of the producibility of the well. Without a high enough producibility, it may not be economical for a driller to enter the production phase and the wellbore may be abandoned.

The porosity of an earth formation is the amount of empty space within the rock. The porosity of a rock may be caused by many factors. As an example, porosity may be caused by deposition, wherein grains of sand are not completely compacted together, or by alteration of the rock, such as when grains are dissolved from the rock by chemical degradation. Because oil, natural gas, or other fluids are stored within the pores of the rock, porosity is an indication of the amount of oil or natural gas stored in a reservoir. Porosity is therefore a typical parameter of the earth formation that is evaluated by formation testing to determine the producibility of a wellbore.

The permeability of an earth formation is the ease with which fluid can flow through the rock. Typically, fluid can flow through the formation in both horizontal and vertical directions. Earth formations are often anisotropic, meaning that the physical properties along the horizontal axis are different than those along the vertical axis. As a consequence, flow within the formation typically moves more easily in the horizontal direction. Because fluid in a formation will only flow if the rock is permeable, the ability of a driller to draw out oil or other natural gases from the wellbore depends on the permeability of the formation. Permeability is another typical parameter of the earth formation that is evaluated by formation testing to determine the producibility of a wellbore.

Formation testing tools can be used to determine various parameters of an earth formation such as the type of fluid present, the amount of fluid present (e.g., porosity), or the ability to extract the fluid from the formation (e.g., permeability). Formation testing can take the form of drillstem formation testing or wireline formation testing. A drillstem formation tester is a formation testing device located on a segment of the drillstem. A wireline formation tester is a device separate from the drillstem. Although both tools are structurally unique and utilized under different conditions, each can be used to ultimately determine the producibility of a wellbore, typically by pressure transient analysis.

Pressure transient analysis typically includes an analysis of reservoir pressure change over time. In a typical formation test, a segment of the wellbore is isolated from the rest of the wellbore. A pump is used to draw liquid from the isolated portion of the wellbore thereby creating a pressure drop within the wellbore. This causes fluid from the formation to fill the isolated portion of the wellbore. This process is called a pressure drawdown. When the pump is shut off, the pressure in the isolated portion of the wellbore begins to increase until the wellbore pressure reaches equilibrium with the reservoir pressure. This process is called the pressure build-up. A pressure transducer can be used to monitor the pressure response over time for both the pressure drawdown and pressure build-up. This raw data can be transmitted to a data acquisition unit for analysis.

Analysis of raw pressure data can involve the use of analytical models that relate the pressure change over time in an induced draw-down or build-up within a wellbore to various formation properties, such as porosity or permeability. Various analytical models exist that represent different methods of formation testing. In a typical analysis, nonlinear regression is used to determine values for the unknown parameters of the earth formation that minimize the error between the real pressure data collected and what is predicted by the analytical model. Alternatively, in a more time-consuming analysis, finite element analysis can be used to approximate the undetermined parameters. In either case, the determined parameters can be used to determine the producibility of the wellbore.

Historically, mathematical assumptions inherent in the analytical models used in pressure transient analysis have introduced inaccuracies into the results obtained. For example, undetermined parameters of the formation derived from the induced pressure drawdown can be significantly different from undetermined parameters derived from the induced pressure build-up. This results in various inaccuracies and inefficiencies because various tests of different types must be performed to obtain consensus results. There is also a potential for overestimating or underestimating the producibility of a well when the undetermined parameters are incorrectly derived. This may result in a significant financial loss to the drilling company.

Therefore, what is needed in the art are improvements in the reliability, time consumption, and accuracy of estimating formation parameters.

### SUMMARY

The present invention relates to methods, systems, and devices for more accurately determining earth formation parameters such as permeability or porosity. Pressure change in an earth formation can be induced and measured by a formation testing tool. An analytical model, related to the induced pressure change, can be refined with correction factors derived from an assumption that the induced fluid flow is hemispherical. A regression analysis can be performed on the refined analytical model and the pressure change data to determine for the earth formation parameters.

A formation testing device according to the present invention can include a pump, one or more probes, and a downhole analysis computer. The pump can be used to induce a flow within the formation. One or more pressure probes can be used to measure the pressure change over time caused by the induced flow. A downhole analysis computer can be used to analyze the collected pressure data to determine the desired formation parameters. The downhole analysis computer can include a data acquisition unit, a database stored in a memory or other computer readable medium, and a processor. The data acquisition unit can receive the pressure data collected from the probes. The database can store analytical models related to the pressure change over time and correction factors derived from an assumption of hemispherical flow. The processor can correct the classic analytical model with the correction factors and perform a regression analysis on the refined analytical model and the collected pressure data to derive formation parameters of interest.

A formation testing system can also be adapted to determine formation parameters uphole after drilling. Such a system can include a wireline tool having a pump that induces a flow within the formation. The tool can also include one or more pressure probes that measure the pressure change caused by the induced flow. A logging cable attached to the wireline tool can be used to transmit the collected date to a computer located on the surface. The surface computer can be similar in function to that used in the tool described above.

### BRIEF DESCRIPTION OF THE DRAWINGS

FIG. 1 illustrates a wellbore with a drillstem formation tester.

FIG. 2 illustrates a draw-down and build-up pressure change in a drillstem test.

FIG. 3 illustrates a wellbore with a wireline formation tester consisting of a sink.

FIG. 4 illustrates a wellbore with a wireline formation tester consisting of a multi-probe assembly.

FIG. 5 illustrates a wellbore with a wireline formation tester consisting of a straddle packer and sink.

FIG. 6 illustrates a wellbore with a wireline formation tester consisting of a straddle packer, sink, and an observation probe.

FIG. 7 illustrates the ideal spherical flow resulting from a formation test.

FIG. 8 illustrates the realistic hemispherical flow resulting from a formation test.

FIG. 9 illustrates the method of correcting the classical analytical model to account for hemispherical flow.

FIG. 10 illustrates the difference between an ideal pressure response and a true pressure response due to skin effects.

FIG. 11 illustrates the database module of a formation tester.

### DETAILED DESCRIPTION

Methods, systems, and devices for determining properties of an earth formation are described herein. The following embodiments of the invention are illustrative only and should not be considered limiting in any respect.

The two major methods of formation testing are drillstem formation testing (DST) and wireline formation testing (WFT). DST can be performed while drilling whereas WFT can be performed post-drilling. Although the formation testing devices are structurally different, both types of devices can be used to record and analyze pressure changes in an earth formation. In both types of formation tests, pressure transient data can be collected and thereafter analyzed to determine formation parameters, such as porosity and permeability.

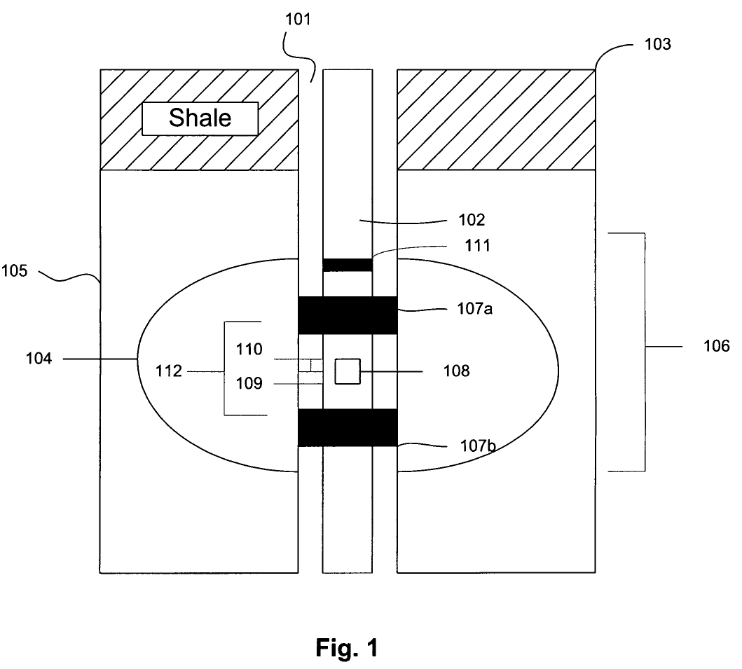

An exemplary drillstem testing tool is illustrated in FIG. 1. Wellbore 101 is a hole that is drilled with drillstem 102 through the earth's surface 103 into reservoir 104 containing oil or other natural gases. In DST the properties of earth formation 105 can be measured in wellbore 101 while drilling. Thus, formation testing device 106 is located on drillstem 102. Formation testing device 106 can include straddles packers 107a-107b, pump 108, pressure transducer 110, and downhole analysis computer 111.

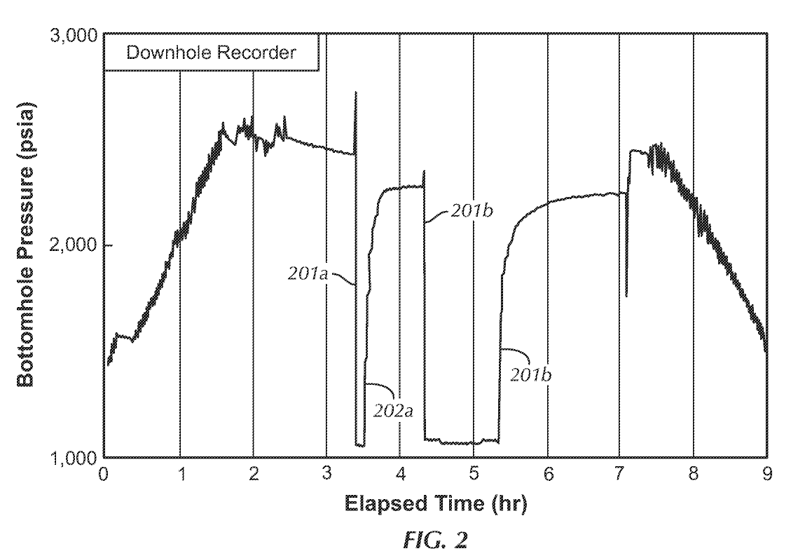

A formation test can be accomplished by inducing fluid flow from reservoir 104 to monitor a pressure change within earth formation 105. Straddle packers 107a-107b can be inflated to isolate a section of the wellbore in straddle packer interval 112. When pump 108 is activated, fluid within straddle packer interval 112 is drawn out, thereby creating a pressure drop in wellbore 101. This causes fluid from reservoir 104 to flow from formation 105 into wellbore 101. Pressure transducer 110 can be used to measure the formation pressure change. Pump 108 can then be deactivated. After deactivation, the pressure within wellbore 101 will increase until it has re-equilibrated with the reservoir pressure of formation 105. This pressure build-up process can also be measured by the pressure transducer 110. The pressure data for the drawdown and build-up processes can be transmitted from pressure transducer 110 to downhole analysis computer 111 located on the drillstem 102 for analysis. FIG. 2 illustrates downhole pressure during a formation test including drawdown 201a-201b build-up 202a-202b features in a DST.

Downhole analysis computer 111 can analyze the pressure data received from pressure transducer 110 to determine parameters such as formation porosity or permeability. Downhole analysis computer 111 can transmit the results of this analysis to surface 103 for review by the driller or other personnel. Additional details of downhole analysis computer 111 are discussed in greater detail below.

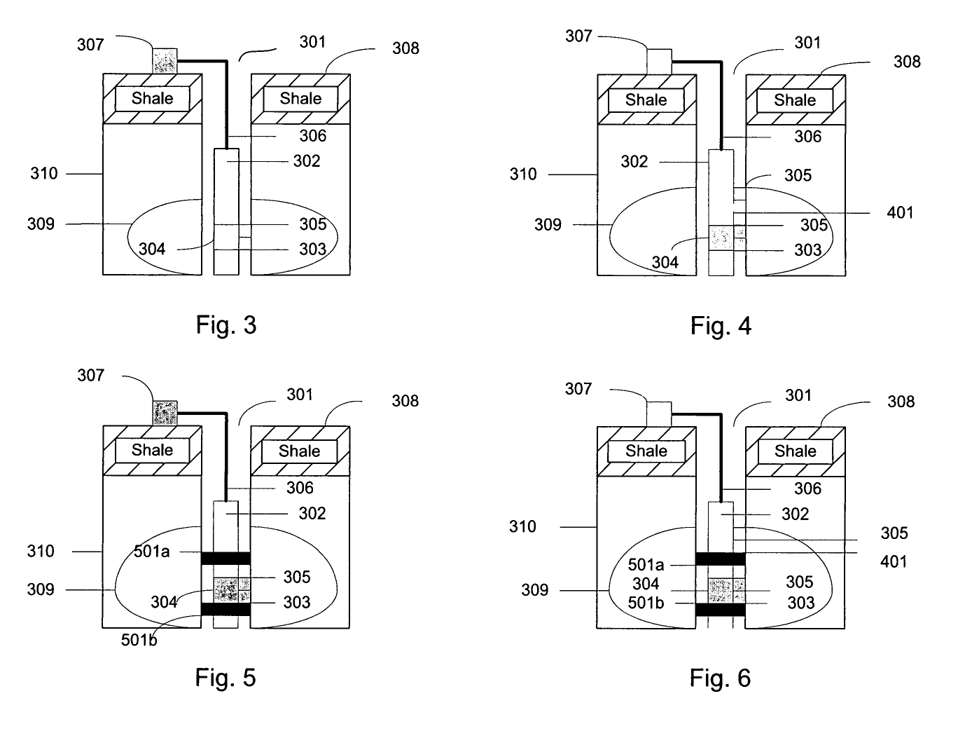

Exemplary wireline formation testing tools are illustrated in FIGS. 3-6. After the wellbore 301 is drilled, the drillstem can be pulled out of the wellbore 301 and a wireline formation tester 302 can be lowered into the wellbore 301 to perform a formation test. Wireline formation tester 302 can include pump 304, pressure transducer 305, and logging cable 306. The wireline formation tester 302 can also include observation probe 401 as illustrated in FIG. 4, straddle packers 501a-501b as illustrated in FIG. 5, or a combination of straddle packers 501a-501b and observation probe 401 as illustrated in FIG. 6.

When pump 304 is activated the pressure in wellbore 301 decreases and fluid flows from reservoir 309. Pressure transducer 305 can be used to measure the pressure change in formation 310 during the drawdown process. Pump 304 can be deactivated, causing the pressure in wellbore 301 to increase until the wellbore pressure and the formation pressure reach equilibrium. Pressure transducer 305 can be used to monitor the pressure change in formation 310 during the build-up process. The data measured by pressure transducer 305 can be transmitted to surface computer 307 via logging cable 306.

Surface computer 307 can analyze the pressure data received from pressure transducer 305 to obtain results such as formation porosity, or formation permeability. Additional details of the surface computer 307 are discussed below.

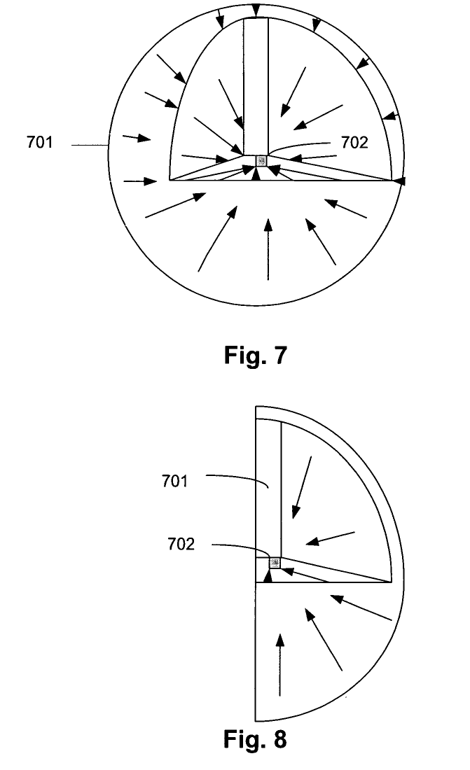

The analytical models that relate to the pressure drawdown or pressure build-up processes in a typical pressure transient analysis depend on the formation testing assembly used. The analytical models can include undetermined earth formation parameters such as porosity or permeability. For example, in a multi-probe system as illustrated in FIG. 4, assuming that the sink 303 sets up a spherical flow in an infinite region as illustrated by FIG. 7, if the formation is anisotropic, the pressure propagation is elliptical in nature and the pressure response of the observation probe takes the form:

$${p}_{DOS} = \frac{1}{2 \sqrt{p}} {\int }_{0}^{{t}_{D}} \frac{{e}^{- ( \frac{( {z}_{vp}^{2} )}{4 \overline{k} {br}_{w}^{2} A} )}}{{b}^{1.5}} {G}_{o} ( b ) d b \qquad ( 1 )$$

where P_{DOS} is the dimensionless pressure response of the observation probe, t_{D} is the dimensionless running time of the test, zᵥₚ is the vertical distance from the observation probe to the sink, r_{w} is the wellbore radius, A=k_{z}/kᵣ such that k_{z} is the vertical permeability and kᵣ is the horizontal permeability, and G is a function of the formation geometry.

In a DST, the analytical model (or models) can be stored in a memory or other computer readable storage medium of the downhole analysis computer. In a WFT, the analytical model can be stored in a memory or other computer readable storage medium of the surface computer. The data collected from the pressure draw-down and/or pressure buildup, can be used to perform a regression analysis with the analytical model. In the regression analysis, the undetermined parameters in the model are solved by a data analysis module, such that the analytical model is a close fit to the raw data collected from formation test. By doing this, the analyst can determine values for the properties of the earth formation.

In a conventional formation test using a multi-probe assembly, pressure data from each probe is analyzed separately. The result will be two different sets of values for identical parameters of the formation. By performing a simultaneous regression analysis of the pressure data from both probes it is possible to derive a single set of earth formation parameters that provides a combined best fit to the models for both probes. The simultaneous regression is performed by minimizing the following total sum of squares function:

$${χ}^{2} = {\sum }_{i = 1}^{N} {( \frac{{y}_{i} - y ( {x}_{iw} \text{:} a )}{{σ}_{i}} )}^{2} + {\sum }_{j = 1}^{M} {( \frac{{z}_{j} - z ( {x}_{jp} \text{:} a )}{{σ}_{j}} )}^{2} \qquad ( 2 )$$

where yᵢ is a measured pressure point from probe 1, y(x_{iw}:a) is an analytical model related to the pressure data recorded from probe 1 at time x_{iw}, zⱼ is a measured pressure point from probe 2, z(xⱼₚ:a) is an analytical model related to the pressure data recorded from probe 2 at time xⱼₚ, a is a vector of earth formation parameters to be estimated, i and j are a selection of points for regression, and σ is the pressure measurement error.

Using classical analytical models, such as (1), can produce different permeability values for the pressure drawdown analysis and the pressure build-up analysis. However, the formation permeability should be independent of the way in which it is measured. This is evidence of an incorrect or overly-simplified assumption of the classical analytical models.

Finite element modeling can be an accurate mode of modeling the induced flow within the formation from a formation test. In finite element modeling, the wellbore and formation region can be divided into sub-regions in a computer program. Each sub-region has its own function representing the flow within that sub-region. The functions of the sub-regions can be simpler than the function representing the entire region. By combining all of the sub-region functions in a matrix along with a vector of unknown parameters, the unknown parameters can be determined. Using finite element modeling, it can be demonstrated that the flow from the formation to the sink induced in a formation test is hemispherical, as opposed to spherical as has heretofore been assumed and as is illustrated in FIG. 8. Therefore, it has been determined that correction of the analytical models to reflect this hemispherical flow can yield substantially improved results.

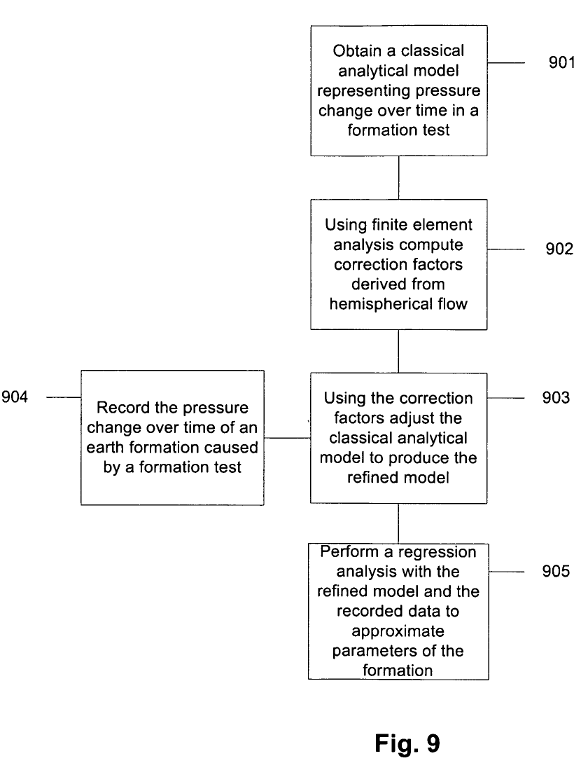

A method of correcting the classical analytical models is illustrated in FIG. 9. An analytical model that relates to the pressure drawdown or pressure build-up in a formation test, and relates to the particular formation testing apparatus, is obtained 901. Using finite element modeling, it is possible to obtain correction factors derived from an assumption of hemispherical flow within the formation 902. These correction factors can be combined with the analytical model to produce a refined model based on hemispherical flow 903. Raw pressure data can be collected from a pressure drawdown or pressure build-up in a formation test 904. A data analysis module can perform a regression analysis using the raw pressure data and the refined model to solve for parameters of the formation 905.

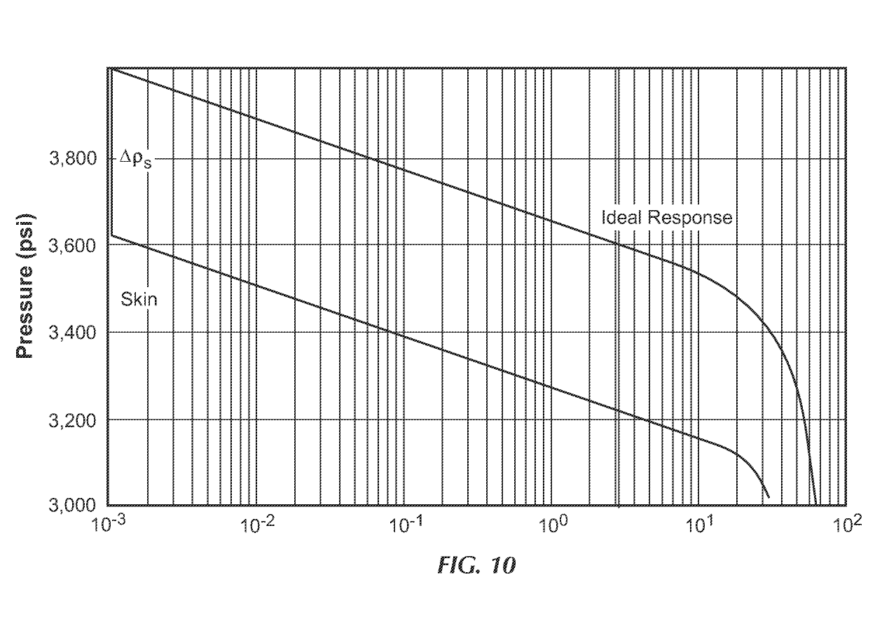

An example of a refined model utilizes skin as a correction factor. Skin is a dimensionless parameter that represents the additional pressure drop in the wellbore as a result of situations such as damage in the wellbore caused by drilling. FIG. 10 illustrates an ideal pressure response from a formation, and a true pressure response from a formation due to skin effects. The basic spherical flow model can be adjusted with skin factors and becomes:

$${p}_{DS} = 1 - \frac{1}{\sqrt{p {t}_{D}}} + {s}_{se} + {s}_{sd} + {s}_{sw}$$

where, Sₛₑ is the negative skin quantity arising from the distortion of the spherical source to an ellipsoid caused by anisotropy, S_{sd} is the effect of mechanical damage on the wellbore, and S_{sw} is the extra dimensionless pressure drop due to the flow blocking effect of the wellbore. The total spherical skin factor becomes Sₛₚₕ where:

Sₛₚₕ=Sₛₑ+S_{sd}+S_{sw}

Using finite element modeling it is possible to obtain a total spherical skin correction factor derived from hemispherical flow. Various suitable finite element models are widely available and are known to those skilled in the art. Alternatively, custom finite element models can also be developed. The skin factor is typically dependent on the ratio of vertical permeability, k_{z}, to horizontal permeability, kᵣ, or A=k_{z}/kᵣ. The skin factor is also dependent on the radius of the probe, rₚ, and the radius of the wellbore, rₑ. Thus, if values for A, rₚ, and r_{w} are entered into a finite element model, the skin factor can be determined. As an example, the following table of values has been derived for the total spherical skin factor assuming a wellbore radius r_{w} of 4.2″ and a probe radius rₚ of 0.125″:

| | 6/A = k_{z}/kᵣ | | | | | |
|---|---|---|---|---|---|---|
| | 1 | 0.3 | 0.1 | 0.03 | 0.01 | 0.003 |
| Sₛₚₕ | 1.1899 | 1.3441 | 1.4603 | 1.8619 | 2.5226 | 3.2934 |

By varying the radius of the wellbore and probe in the above finite element analysis, it is possible to derive a dataset of skin factor values for various formation system parameters. Once the dataset of skin factors derived from a hemispherical flow assumption has been determined, the classical analytical models based on spherical flow can be adjusted to more accurately model hemispherical flow. These adjusted models can then be used to estimate the desired formation parameters in the data analysis module.

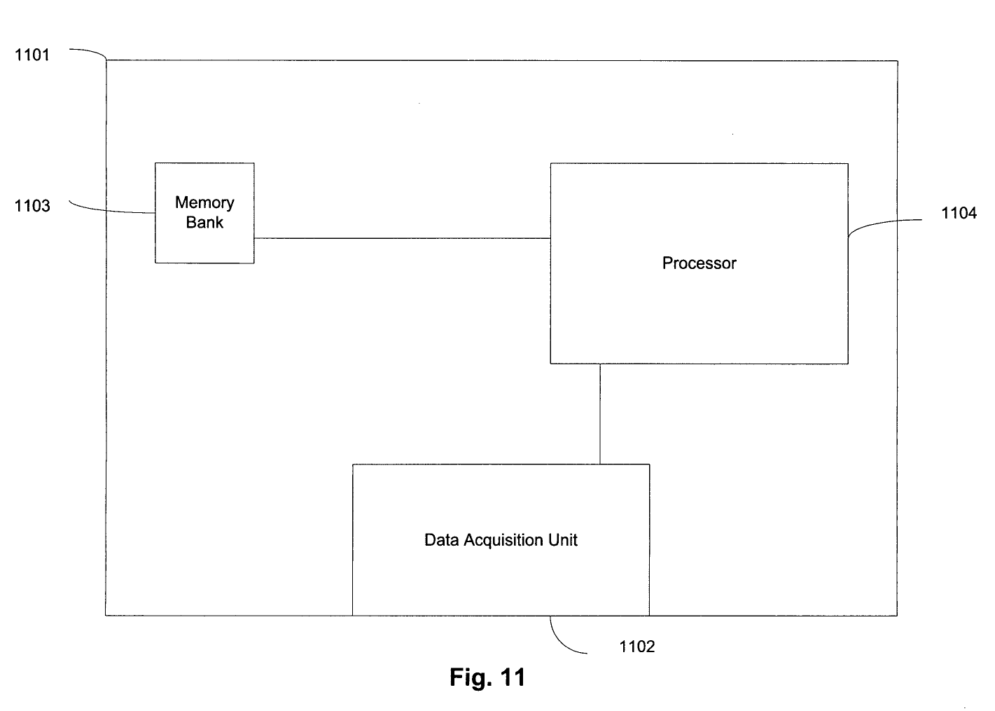

The downhole analysis computer in a DST, and the surface computer in a WFT are both data analysis modules that perform a similar function. The hardware used in a downhole analysis computer and a surface computer will necessarily differ based primarily on the demands of the operating environment. These different types of systems are generally well understood by those skilled in the art and will not be discussed in detail herein. However, the basic operation of the two types of systems is similar and is as follows. An exemplary data analysis module is illustrated schematically in FIG. 11. Data analysis module 1101 includes data acquisition unit 1102, memory 1103, and processor 1104. During a formation test, pressure drawdown and build-up data is transmitted to data analysis module 1101 and collected at data acquisition unit 1102. Memory 1103 can be used to store the analytical models that represent the pressure drawdown or pressure build-up process for the type of formation tester in use. Additionally, memory 1103 can store correction factors to adjust the analytical model in use. Memory 1103 can also be used to store recorded pressure data, or a separate memory can be provided for this purpose. The processor 1104 can refine the analytical model and can use the refined analytical model and the pressure data to determine the formation parameters and transmit those results to the analyst.

When using the refined analytical models derived from an assumption of hemispherical flow, it has been demonstrated that analysis of the pressure drawdown and pressure build-up produces substantially identical formation permeability values. Thus, the analyst can be confident in the results obtained and thereby make a more accurate prediction of the producibility of the wellbore.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112. According, the foregoing description of preferred and other embodiments is not intended to limit or restrict the scope or applicability of the inventive concepts conceived of by the Applicant.

What is claimed is:

1. A method of determining one or more properties of an earth formation, the method comprising:
recording data corresponding to a pressure change as a function of time within the formation, wherein the pressure change is caused by induced flow from the formation;
deriving a refined analytical model of the formation, wherein the refined analytical model defines one or more relationships between the recorded data and the one or more properties of the earth formation and wherein the refined analytical model includes one or more correction factors derived from an assumption that the induced flow is hemispherical; and
executing a computer program to perform a regression analysis of the refined analytical model and the recorded data to solve for the one or more properties of the earth formation.

2. The method of claim 1 wherein the one or more parameters are selected from the group consisting of horizontal permeability, vertical permeability, and porosity.

3. The method of claim 1 wherein the one or more correction factors are derived by finite element analysis.

4. A measuring while drilling formation testing tool configured to determine one or more formation properties, the tool comprising:
a pump configured to induce a fluid flow from the formation;
one or more pressure measurement probes; and
a downhole analysis computer comprising:
a data acquisition unit programmed to receive and record pressure data from the one or more pressure probes as a function of time;
a computer readable medium having stored therein one or more analytical models defining one or more relationships between the recorded data and the one or more formation properties and one or more correction factors derived from an assumption that the induced flow is hemispherical; and
a processor operatively coupled to the data acquisition unit and the computer readable medium, the processor programmed to derive a refined analytical model from the one or more analytical models and the one or more correction factors and to perform a regression analysis of the refined analytical model and the recorded data to solve for the one or more formation properties.

5. The tool of claim 4 wherein the formation testing tool is a drillstem tester.

6. The tool of claim 4 wherein the one or more parameters are selected from the group consisting of horizontal permeability, vertical permeability, and porosity.

7. The tool of claim 4 wherein the one or more correction factors are derived by finite element analysis.

8. The tool of claim 4 wherein the formation testing tool includes at least one active probe and at least one observation probe.

9. A formation testing system configured to determine one or more formation parameters, the system comprising:
a formation testing tool comprising a pump configured to induce a fluid flow from the formation and one or more pressure measurement probes;
a surface computer; and
a logging cable connecting the formation testing tool to a surface computer and adapted to transmit pressure data from the one or more probes to the surface computer;
wherein the surface computer comprises:
a data acquisition unit programmed to receive and record pressure data from the one or more pressure probes as a function of time;
a computer readable medium having stored therein one or more analytical models defining one or more relationships between the recorded data and the one or more formation properties and one or more correction factors derived from an assumption that the induced flow from the formation to the sink is hemispherical; and
a processor operatively coupled to the data acquisition unit and the computer readable medium, the processor programmed to derive a refined analytical model from the one or more analytical models and the one or more correction factors and to perform a regression analysis of the refined analytical model and the recorded data to solve for the one or more formation properties.

10. The system of claim 9 wherein the one or more parameters are selected from the group consisting of horizontal permeability, vertical permeability, and porosity.

11. The system of claim 9 wherein the one or more correction factors are derived by finite element analysis.

12. The system of claim 9 wherein the formation testing tool includes at least one active probe and at least one observation probe.
